(19) United States
(12) Patent Application Publication
(10) Pub. No.: US 2005/0125615 A1
(43) Pub. Date: Jun. 9, 2005

(54) Methods and apparatus for writing an LRU bit

(75) Inventors: Peter T. Freiburger, Rochester, MN (US); Ryan C. Kivimagi, Chatfield, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/728,300

(22) Filed: Dec. 4, 2003

(51) Int. Cl. G06F 13/00

(52) U.S. Cl. 711/160

(57) ABSTRACT

In a first aspect, a first method is provided for writing an LRU indicator. The first method includes the steps of (1) activating one of a first word line that corresponds to a first memory array and a second word line which corresponds to a second memory array; (2) employing the first word line, when activated, for writing to the first memory array and for writing the LRU indicator; and (3) employing the second word line, when activated, for writing to the second memory array and for writing the LRU indicator. Numerous other aspects are provided.

### FIELD OF THE INVENTION

The present invention relates generally to integrated circuits, and more particularly to methods and apparatus for writing a bit within an integrated circuit.

### BACKGROUND

FIG. 1 is a block diagram of a conventional integrated circuit (IC) 100 that employs a least recently used (LRU) bit. With reference to FIG. 1, the IC 100 may be coupled to and/or include a first memory array 102 and a second memory array 104. The first memory array 102 is used for storing a first group of data and the second memory array 104 is used for storing a second group of data. The IC 100 is adapted to write data to the first memory array 102 using (e.g., activating) a first word line 106 (e.g., WLA), and to write data to the second memory array 104 using (e.g., activating) a second word line 108 (e.g., WLB).

An application running on a computer (not shown) which includes the IC 100 may need to know to which memory array 102, 104 data is last written (e.g., to determine which memory array is the “least recently used”). The IC 100 uses an LRU bit 110 to indicate such a memory array. That is, after the IC 100 writes data to the first memory array 102 or the second memory array 104, the IC 100 employs the LRU bit 110 to indicate the memory array 102, 104 to which the data was written. In the embodiment shown, the LRU bit 110 is shared by the first 102 and second memory arrays 104.

The value of the LRU bit 110 is stored in a cell 112 included in the first memory array 102. The IC 100 may write the LRU bit 110 using the first word line 106 after writing data to the first memory array 102 or second memory array 104. Therefore, only a single port (e.g., the first word line 106) is used for accessing the cell 112 for storing the LRU bit 110. More specifically, the IC 100 may activate the first word line 106 to write data to the first memory array 102 and to write the LRU bit 110 to the cell 112. Alternatively, the IC 100 may activate the second word line 108 to write data to the second memory array 104 and then activate the first word line 106 to write the LRU bit 110 to the cell 112 such that the LRU bit 110 indicates the second memory array 104 is the memory array to which data is last written. Therefore, when writing data to the second memory array 104 and implementing the LRU bit 110, two word lines are activated. Such a method for writing the LRU bit 110 inefficiently consumes power.

### SUMMARY OF THE INVENTION

In a first aspect of the invention, a first method is provided for writing a least recently used (LRU) indicator. The first method includes the steps of (1) activating one of a first word line that corresponds to a first memory array and a second word line which corresponds to a second memory array; (2) employing the first word line, when activated, for writing to the first memory array and for writing the LRU indicator; and (3) employing the second word line, when activated, for writing to the second memory array and for writing the LRU indicator.

In a second aspect of the invention, a first apparatus is provided that includes a first memory array coupled to a first word line and a first bit line and a second memory array coupled to a second word line and a second bit line. The first apparatus also includes a cell for storing an LRU indicator coupled to the first and second memory arrays, and an integrated circuit (IC) coupled to the first and second memory arrays. The IC is adapted to (1) activate one of the first word line and the second word line; (2) employ the first word line, when activated, for writing to the first memory array and for writing the LRU indicator; and (3) employ the second word line, when activated, for writing to the second memory array and for writing the LRU indicator. Numerous other aspects are provided.

Other features and aspects of the present invention will become more fully apparent from the following detailed description, the appended claims and the accompanying drawings.

### BRIEF DESCRIPTION OF THE FIGURES

FIG. 1 is a block diagram of a conventional integrated circuit (IC) that writes a least recently used (LRU) bit.

FIG. 2 is a block diagram of an exemplary IC for writing a bit or similar indicator in accordance with an embodiment of the present invention.

FIG. 3 illustrates an exemplary circuit for storing a bit or similar indicator in accordance with an embodiment of the present invention.

FIG. 4 illustrates an exemplary method for writing a bit or similar indicator in accordance with an embodiment of the present invention.

### DETAILED DESCRIPTION

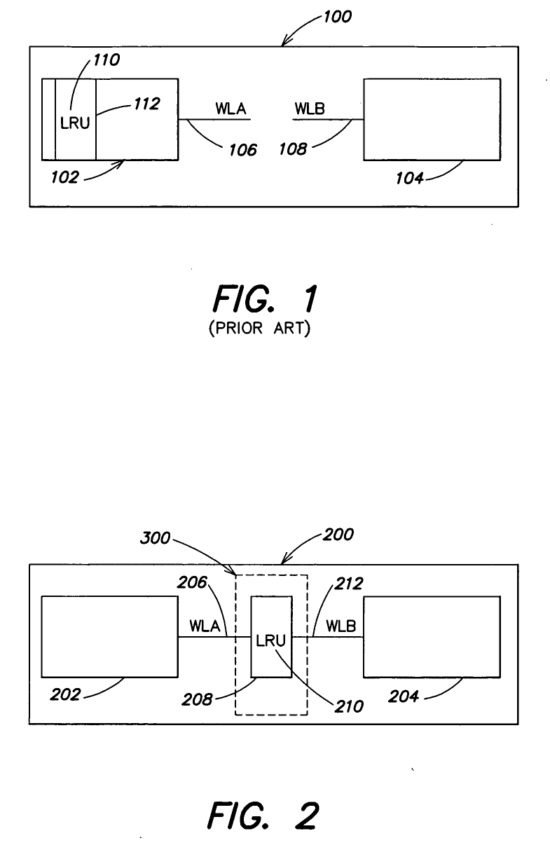

FIG. 2 is a block diagram of an exemplary integrated circuit (IC) 200 for writing a bit or similar indicator (i.e., an LRU indicator) in accordance with an embodiment of the present invention. The exemplary IC 200 may be coupled to and/or include a first memory array 202 and a second memory array 204. The first 202 and second memory arrays 204 may be grouped together forming a pair of memory arrays. The first memory array 202 may be a sub-array included in a larger first memory (not shown). The first memory array 202 may be used for storing data (e.g., a first group of data). The first memory array 202 may be coupled to a corresponding first word line 206 (e.g., WLA), which may be used for writing data to the first memory array 202. More specifically, the IC 200 may activate the first word line 206 (e.g., by asserting a signal on the first word line 206) to write data to the first memory array 202.

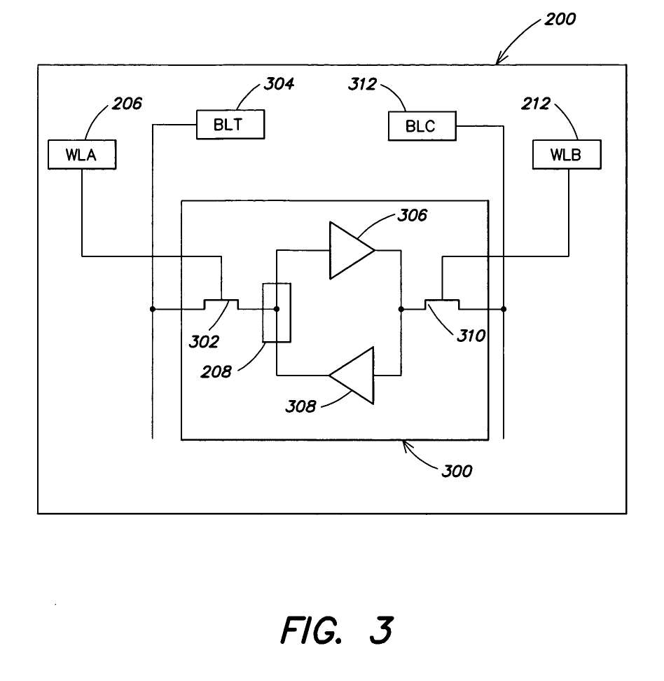

The first word line 206 may be coupled to a cell 208 included in the IC 200. The cell 208 may be used for storing a bit 210 or similar indicator (i.e., an LRU indicator) of data, which indicates a memory array 202, 204 to which data is last written. The bit 210 may indicate information other than a memory array 202, 204 to which data is last written. The detail of an exemplary circuit 300 which includes the cell 208 is described below with reference to FIG. 3. The first word line 206 may be used for storing data (e.g., a bit) in the cell 208. More specifically, the IC 200 may activate the first word line 206 to write data, such as an LRU bit, in the cell 208. For example, the IC 200 may write the bit 210 or similar indicator after writing data to the first memory array 202.

Similar to the first memory array 202, the second memory array 204 included in the IC 200 may be a sub-array included in the larger first memory (not shown). The second memory array 204 may be used for storing data (e.g., a second group of data). The second memory array 204 may be coupled to a corresponding second word line 212 (e.g., WLB), which may be used for writing data to the second memory array 204. More specifically, the IC 200 may activate the second word line 212 (e.g., by asserting a signal on the second word line 212) to write data to the second memory array 204.

Similar to the first word line 206, the second word line 212 may be coupled to the cell 208 and may be used for storing data, such as a bit 210 (e.g., LRU bit), in the cell 208. For example, after the IC 200 writes data to the second memory array 204, the IC 200 may write the bit 210 (e.g., LRU bit) using the second word line 212. Therefore, the IC 200 for writing a bit 210 may include a cell 208 to which data, such as an LRU bit, may be written using one of a first and second port. The first word line 206 may serve as the first port and the second word line 212 may serve as the second port. In this manner, the first 202 and second memory arrays 204 may share the cell 208, which may be used for storing a bit 210, such as an LRU bit, for example. The first 202 and second memory arrays 204 may be grouped together forming a pair of memory arrays. Therefore, a pair of memory arrays may share the cell 208 for storing a bit 210 (e.g., LRU bit).

FIG. 3 illustrates an exemplary circuit 300 for storing a bit 210 or similar indicator. The IC 200 for writing the bit 210 (e.g., LRU bit) may be coupled to and/or include the exemplary circuit 300 for storing the bit 210. The exemplary circuit 300 may include pass-gate circuitry, which includes a first transistor 302 (e.g., an NFET) coupled (e.g., via a gate terminal) to the first word line 206 such that the first word line 206 may serve to activate the first transistor 302. The first transistor 302 may be coupled (e.g., via a drain or source terminal) to a first bit line 304 (e.g., Bit Line True (BLT)), and the input of a first logic device 306, such as a first inverter, and the output of a second logic device 308, such as a second inverter (e.g., via a source or drain terminal of the first transistor 302). Other types of transistors and/or logic devices may be used.

The exemplary circuit 300 may include a second transistor 310, such as an NFET, coupled (e.g., via a gate terminal) to the second word line 212 such that the second word line 212 may serve to activate the second transistor 310. The second transistor 310 may be coupled (e.g., via a source or drain terminal) to a second bit line 312 (e.g., Bit Line Complement (BLC)), and the output of the first logic device 306, such as the first inverter, and the input of the second logic device 308, such as the second inverter 308 (e.g., via a drain or source terminal of the second transistor 310). The node at the input of the first logic device 306 and the output of the second logic device 308 may serve as a cell 208 for storing data, such as a bit 210 (e.g., LRU bit). Alternatively, the cell 208 may be located at another node included in the IC 300. For example, the node at the output of the first logic device 306 and the input of the second logic device 308 may serve as the cell 208 for storing data, such as the LRU bit. In other embodiments, the cell 208 may be included in circuitry other than a pass-gate.

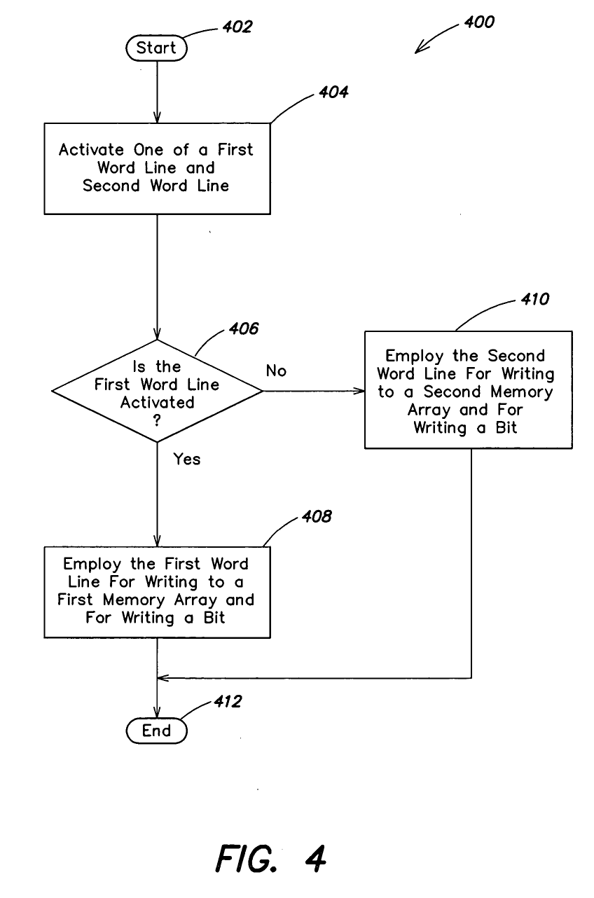

The operation of the exemplary IC 200 for writing a bit 210 or similar indicator is now described with reference to FIGS. 2-3, and with reference to FIG. 4 which illustrates an exemplary method for writing the bit 210 or similar indicator. With reference to FIG. 4, in step 402, the method 400 begins. In step 404, one of a first word line 206 and a second word line 212 may be activated. For example, a signal on one of the first word line 206 and the second word line 212 may be changed from a first logic state (e.g., a low logic state) and set to a second logic state (e.g., a high logic state) to activate the first 206 or second word line 212. Alternatively, a signal on one of the first word line 206 and the second word line 212 may be changed from the second logic state and set to the first logic state to activate the first 206 or second word line 212.

Thereafter, step 406 may be performed. In step 406, it is determined whether the first word line 206 is activated. For example, if a signal on the first word line 206 is changed from a first logic state and set to a second logic state, it is determined the first word line 206 is activated.

Thereafter, step 408 may be performed. In step 408, the first word line 206 may be employed for writing to a first memory array 202 and for writing a bit 210 or similar indicator. More specifically, during a write operation the first word line 206, which is coupled to the first memory array 202, may be activated and used for writing data in a specified address of the first memory array 202. In this manner, bits of data may be stored in one or more cells (not shown) included the first memory array 202. Therefore, the first word line 206 may be employed for writing to the first memory array 202.

The first word line 206 may be coupled to the exemplary circuit 300 for storing a bit 210, (e.g., LRU bit). More specifically, the first word line 206 may be coupled, via the first transistor 302, to the cell 208 which is shared by the first 202 and second memory arrays 204. The first word line 206 may be employed as a first port to the cell 208. Because the first port (e.g., the first word line 206) may be coupled to the gate terminal of the first transistor 302 (e.g., NFET) included in the exemplary circuit 300 for storing the bit 210, activating the first word line 206 (e.g., the first port) serves to activate the first transistor 302. Because only one of the first 206 and second word lines 212 is activated (e.g., fired) during a write operation, in the above example, the second word line 212, which is coupled to the gate terminal of the second transistor 310 (e.g., NFET) included in the exemplary circuit 300, is not activated (e.g., remains at a low logic state) and does not activate the second transistor 310 (e.g., NFET).

Further, during a write operation, the IC 200 may set a signal on both bit lines 304, 312 (e.g., Bit Line True (BLT) and Bit Line Complement (BLC)) coupled to the exemplary circuit 300 for storing the bit 210 (e.g., LRU bit) to a first logic state (e.g., a low logic state). Therefore, when the first word line 206 is activated (e.g., to write data to the first memory array 202), the signal value at the input of the first logic device 306 and the output of the second logic device 308 is of a low logic state. Consequently, a signal or bit of a low logic state (e.g., 0) may be stored in the cell 208 for storing the bit 210 (e.g., LRU bit). Thereafter, step 412 may be performed. In step 412, the method 400 ends.

Alternatively, if a signal (e.g., a signal of a high logic state) is asserted on the second word line 212, for example, it is determined, in step 406, the first word line 206 is not activated. Therefore, during step 404, the second word line 212 was activated.

Thereafter, step 410 may be performed. In step 410, the second word line 212 may be employed for writing to a second memory array 204 and for writing a bit 210 or similar indicator. More specifically, similar to the first word line 206, during a write operation, the IC 200 may activate the second word line 212, which is coupled to the second memory array 204, and use the second word line 212 for writing data in a specified address of the second memory array 204. Therefore, bits of data may be stored in one or more cells (not shown) included in the second memory array 204.

Similar to the first word line 206, the second word line 212 may be coupled to the exemplary circuit 300 for storing a bit 210 (e.g., LRU bit). More specifically, the second word line 212 may be coupled, via the second transistor 310 and second logic device 308, for example, to the cell 208. The second word line 212 may be employed as a second port to the cell 208. Because the second port (e.g., the second word line 212) may be coupled to a gate terminal of the second transistor 310 (e.g., NFET) included in the IC 300 for storing a bit or similar indicator, activating the second word line 212, for example, by asserting a signal of a high logic state on the second word line 212 serves to activate the second transistor 310. As stated, during a write operation only one of the first 206 and second word lines 212 is activated or fired. Therefore, in the above example, the first word line 206 is not activated and consequently, does not activate the first transistor 302.

As stated above, during a write operation, the IC 200 may set a signal on both bit lines 304, 312 (e.g., BLT and BLC) coupled to the exemplary circuit 300 to a first logic state (e.g., a low logic state). Thus, when the second word line 212 is activated, for example, to write data to the second memory array 204, the signal value at the output of the first logic device 306 and the input of the second logic device 308 is of a low logic state (e.g., 0). Consequently, a signal or bit of a high logic state (e.g., 1) may be stored in the cell 208 for storing the bit 210 (e.g., LRU bit). Thereafter, step 412 may be performed, in which the method 400 ends.

Through the use of the method 400 of FIG. 4, an application running on a computer (not shown), which includes the IC 200 may access the value stored in the cell 208 for storing the bit 210 or similar indicator to determine to which memory array 202, 204 data was last written. For example, if the value of the bit 210 (e.g., LRU bit) stored in the cell 208 is of a low logic state (e.g., 0), data is last written to the first memory array 202. Therefore, the data stored in the second memory array 204 is older than the data stored in the first memory array 202. Alternatively, if the value of the bit 210 (e.g., LRU bit) stored in the cell 208 is of a high logic state (e.g., 1), data is last written to the second memory 204. Therefore, the data stored in the first memory array 202 is older than the data stored in the second memory array 204. In other embodiments, the same signal values may be used for indicating the memory array 202, 204 to which data is last written, or vice versa.

By allowing a pair of memory arrays (e.g., the first memory array 202 and second memory array 204) included in an IC 200 for writing a bit 210 or similar indicator to share a cell 208, a single word line 206, 212 may be employed or activated for writing data to the first memory array 202 and the bit 210 or for writing data to the second memory array 204 and the bit 210. Because only a single word line 206, 212 is activated for writing data to a memory array 202, 204 included in a pair of memory arrays and for writing the bit 210, the IC 200 for writing the bit 210 (e.g., an LRU bit) efficiently consumes power.

The foregoing description discloses only exemplary embodiments of the invention. Modifications of the above-disclosed embodiments of the invention which fall within the scope of the invention will be readily apparent to those of ordinary skill in the art. For instance, although in the above embodiments, the IC 200 includes a first 202 and second memory array 204, in other embodiments, the IC 200 may include a memory (not shown), which includes a plurality of memory sub-arrays (e.g., the first 202 and second memory arrays 204). For example, the memory (not shown) may include eight memory sub-arrays, which may be grouped into pairs of memory sub-arrays. In such an embodiment, each pair of memory sub-arrays share one or more cells 208 for storing a bit 210 (e.g., an LRU bit).

Further, although in one or more of the above embodiments, the IC 200 includes a first word line 206, second word line 212, and cell 208, in other embodiments, the IC 200 may include a first plurality of word lines coupled to the first memory array 202, second plurality of word lines coupled to the second memory array 204, and a plurality of cells. Each of the plurality of cells corresponds to and is coupled to (e.g., shared by) a word line from each of the first and second plurality of word lines. In this manner, a column of cells 208, each of which stores a bit 210, such as an LRU bit, may be shared between the first 202 and second memory arrays 204. In one embodiment, the first 202 and second memory arrays 204 may each include thirty-two word lines. Other numbers of word lines may be used. In another embodiment, one or more memory sub-arrays included in the first and/or second plurality of memory sub-arrays may include thirty-two word lines. Other numbers of word lines may be used.

Accordingly, while the present invention has been disclosed in connection with exemplary embodiments thereof, it should be understood that other embodiments may fall within the spirit and scope of the invention as defined by the following claims.

1. A method for writing a least recently used (LRU) indicator comprising:
activating one of a first word line that corresponds to a first memory array and a second word line which corresponds to a second memory array;
employing the first word line, when activated, for writing to the first memory array and for writing the LRU indicator; and
employing the second word line, when activated, for writing to the second memory array and for writing the LRU indicator.

2. The method of claim 1 further comprising setting a signal on a first and second bit line to a first logic state.

3. The method of claim 2 wherein setting a signal on the first and second bit line to a first logic state includes setting a signal on the first and second bit line to a low logic state.

4. The method of claim 1 wherein activating one of the first word line that corresponds to the first memory array and the second word line which corresponds to the second memory array includes setting a signal on one of the first word line and the second word line to a second logic state.

5. The method of claim 4 wherein setting a signal on one of the first word line and the second word line to a second logic state includes setting a signal on one of the first word line and the second word line to a high logic state.

6. The method of claim 1 wherein employing the first word line, when activated, for writing to the first memory array and for writing the LRU indicator includes employing the first word line, when activated, for writing to the first memory array and for activating a first port of a cell that stores the LRU indicator; and
wherein employing the second word line, when activated, for writing to the second memory array and for writing the LRU indicator includes employing the second word line, when activated, for writing to the second memory array and for activating a second port of the cell that stores the LRU indicator.

7. The method of claim 1 wherein employing the first word line, when activated, for writing to the first memory array and for writing the LRU indicator includes employing the first word line, when activated, for writing to the first memory array and for storing a bit of a first logic state in a cell that stores the LRU indicator; and
wherein employing the second word line, when activated, for writing to the second memory array and for writing the LRU indicator includes employing the second word line, when activated, for writing to the second memory array and for storing a bit of a second logic state in the cell that stores the LRU indicator.

8. An apparatus for writing an LRU indicator comprising:
a first memory array coupled to a first word line and a first bit line;
a second memory array coupled to a second word line and a second bit line;
a cell for storing the LRU indicator coupled to the first and second memory arrays;
an integrated circuit (IC) coupled to the first and second memory arrays, and adapted to:
activate one of the first word line and the second word line;
employ the first word line, when activated, for writing to the first memory array and for writing the LRU indicator; and
employ the second word line, when activated, for writing to the second memory array and for writing the LRU indicator.

9. The apparatus of claim 8 wherein the IC is further adapted to set a signal on the first and second bit lines to a first logic state.

10. The apparatus of claim 9 wherein the IC is further adapted to set a signal on the first and second bit line to a low logic state.

11. The apparatus of claim 8 wherein the IC is further adapted to set a signal on one of the first word line and the second word line to a second logic state.

12. The apparatus of claim 11 wherein the IC is further adapted to set a signal on one of the first word line and the second word line to a high logic state.

13. The apparatus of claim 8 wherein the IC is further adapted to:
employ the first word line, when activated, for writing to the first memory array and for activating a first port of the cell that stores the LRU indicator; and
employ the second word line, when activated, for writing to the second memory array and for activating a second port of the cell that stores the LRU indicator.

14. The apparatus of claim 8 wherein the IC is further adapted to:
employ the first word line, when activated, for writing to the first memory array and for storing a bit of a first logic state in the cell that stores the LRU indicator; and
employ the second word line, when activated, for writing to the second memory array and for storing a bit of a second logic state in the cell that stores the LRU indicator.

15. The apparatus of claim 8 wherein the cell is included in a pass-gate circuit.

16. The apparatus of claim 15 wherein the cell is a node at an input of a first logic device and an output of a second logic device of the pass-gate circuit.

17. The apparatus of claim 15 wherein the cell is a node at an output of a first logic device and an input of a second logic device of the pass-gate circuit.
